(19) United States
(12) Patent Application Publication
(10) Pub. No.: US 2024/0409239 A1
(43) Pub. Date: Dec. 12, 2024

(54) Predicting Structural Loads

(71) Applicant: Textron Innovations Inc., Providence, RI (US)

(72) Inventor: Juan Li, Keller, TX (US)

(21) Appl. No.: 18/333,354

(22) Filed: Jun. 12, 2023

(51) Int. Cl. B64F 5/60; G05B 13/02

(52) U.S. Cl. CPC B64F 5/60; G05B 13/0265

(57) ABSTRACT

In certain embodiments, a method includes accessing, by a processing device, actual operating condition information for an operating condition parameter associated with actual operation of a vehicle. The actual operating condition information corresponds to sensor measurements associated with a vehicle component of the vehicle. The method includes analyzing, by the processing device and using an artificial intelligence model, the actual operating condition information to generate predicted load information for the vehicle component. The method includes determining, according to the predicted load information, an estimated fatigue life for the vehicle component that is individualized for the vehicle component.

### TECHNICAL FIELD

This disclosure relates generally to machine components, and, in particular embodiments, to predicting structural loads.

### BACKGROUND

Aircraft, such as rotorcraft, include a number of components. Over time the components of an aircraft may be subject to structural loads through operation of the vehicle, environmental conditions, and/or other factors. The structural loads experienced by any given component may vary from aircraft-to-aircraft depending on actual usage of the aircraft and, for a particular aircraft, may vary over time due to the actual usage of the particular aircraft.

### SUMMARY

In certain embodiments, a rotorcraft includes a rotorcraft component, a plurality of sensors, and one or more non-transitory computer storage media storing programming for execution by one or more processors. The programming includes instructions to access actual operating condition information for operating condition parameters of the rotorcraft. The actual operating condition information corresponds to sensor measurements from the plurality of sensors and is associated with the rotorcraft component. The programming includes instructions to analyze, using an artificial intelligence model, the actual operating condition information to generate initial predicted load information for the rotorcraft component. The initial predicted load information includes a first output data signal in a frequency domain. The programming includes instructions to convert the initial predicted load information to a time domain to generate predicted load information for the rotorcraft component by applying a transform operation to the first output data signal to generate a second output data signal in a time domain. The programming includes instructions to determine, according to the predicted load information, an estimated fatigue life for the rotorcraft component that is individualized for the rotorcraft component.

In certain embodiments, a method includes accessing, by a processing device, actual operating condition information for an operating condition parameter associated with actual operation of a vehicle. The actual operating condition information corresponds to sensor measurements associated with a vehicle component of the vehicle. The method includes analyzing, by the processing device and using an artificial intelligence model, the actual operating condition information to generate predicted load information for the vehicle component. The method includes determining, according to the predicted load information, an estimated fatigue life for the vehicle component that is individualized for the vehicle component.

In certain embodiments, a computer system includes one or more processing units and one or more non-transitory computer-readable storage media storing programming for execution by the one or more processing units. The programming includes instructions to access actual operating condition information for an operating condition parameter associated with actual operation of a vehicle. The actual operating condition information corresponds to sensor measurements associated with a vehicle component of the vehicle. The programming includes instructions to analyze, using an artificial intelligence model, the actual operating condition information to generate predicted load information for the vehicle component. The programming includes instructions to determine, according to the predicted load information, an estimated fatigue life for the vehicle component that is individualized for the vehicle component.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates aspects of an example rotorcraft, according to certain embodiments;

FIG. 2 illustrates a representation of a flight control system for a rotorcraft, according to certain embodiments;

FIG. 3 illustrates an example system for predicting structural load information and estimating vehicle component fatigue, according to certain embodiments;

FIG. 4 illustrates a flow diagram of an example method for training an AI model for generating predicted load information for a vehicle component, according to certain embodiments;

FIG. 5 illustrates a flow diagram of an example method for predicting structural loads and estimating vehicle component fatigue, according to certain embodiments;

FIG. 6 illustrates additional details regarding training an AI model and processing actual data using the trained AI model;

FIG. 7 illustrates an example machine learning model, according to certain embodiments; and

FIG. 8 is a block diagram of an example computer system, according to certain embodiments.

### DETAILED DESCRIPTION OF ILLUSTRATIVE EMBODIMENTS

Fatigue loading generally refers to the gradual and progressive weakening of a structural element due to the loading (the application of stress) and unloading (the release of the stress) of the structural element repeatedly over time. The stress level experienced generally is below a maximum strength or stress of the structural element, such that the structural member is unlikely to fail (e.g., crack or otherwise break) from a single application of the loading and/or unloading, and instead experiences a weakening over time.

Machine components, such as vehicle components (e.g., aircraft or automobile components) may be subject to fatigue loading during operation of the machine (e.g., vehicle). Taking an aircraft (e.g. a rotorcraft) as an example, aircraft components (e.g., rotorcraft components) may experience fatigue loading due at least in part to the various forces that act on the aircraft components during operation, such as during take-off, flight, and landing.

Over time fatigue loading may affect the life of a vehicle component. For example, a relatively greater amount of fatigue loading may shorten the useful life of the vehicle component before the vehicle component fails, such as by cracking, breaking, or otherwise becoming unable to perform its intended role capably, reliably, and/or safely. Of course, with certain types of vehicle components, failure of the vehicle component could be catastrophic.

Thus, estimating a fatigue life of a vehicle component may be useful for determining a maintenance schedule for the vehicle component, which could include servicing the vehicle component, replacing the vehicle component, retiring the vehicle, or performing another suitable action. The fatigue life of a component may refer to a time at which the component is expected to fail. For example, fatigue life could be expressed as a number of loading cycles of a particular nature that a component can sustain before a particular kind of failure occurs, though this disclosure contemplates fatigue life being expressed in any suitable manner.

The fatigue life of a component may be dependent on the structural load the component experiences over time. The fatigue loading that a component suffers, however, may be dependent on the usage of the vehicle. Taking an aircraft as an example, the usage of the aircraft, including flight conditions (both environmental and operational), aircraft payload, and any of a number of other factors may vary from aircraft to aircraft. Variation of structural loads from vehicle to vehicle can make it difficult to estimate a fatigue life for vehicle components generally that can be considered reliable across any vehicle in which that component may be installed. Additionally, even for an instance of a component with a given vehicle, the fatigue loading that a component suffers may vary over time due to variations in usage of the vehicle over time. However, it is difficult to measure or estimate real-time dynamic loading for certain vehicle components. Taking a rotorcraft as an example, it can be difficult to measure or estimate real-time dynamic loading for certain rotorcraft components, including certain critical components such as pitch link, fuselage, and rotor blades).

Due at least in part to these difficulties, component part manufacturers and/or vehicle manufacturers may estimate fatigue life based on worst (or nearly worst) case scenarios of vehicle usage for all vehicles, regardless of actual usage on a particular vehicle, and may base component maintenance/replacement schedules on those estimates. This imprecise technique can lead to overly conservative component life assumptions that result in unnecessarily replacing a component or retiring a vehicle, leading to waste and increased costs.

Certain embodiments of this disclosure provide techniques for predicting structural loads on machine components using actual operating condition information captured from sensors during operation of a machine and analyzing those values using one or more artificial intelligence (AI) models to generate predicted structural loads on the machine components. The predicted structural loads can be used to determine individualized estimated fatigue lives for the components and to generate, based on those individualized estimated fatigue lives, individualized maintenance recommendations for the components.

In an example in which the machine is a rotorcraft, certain embodiments provide techniques for predicting structural loads on certain rotorcraft components using actual operating condition information (e.g., flight parameter values) captured from sensors during operation of the rotorcraft and analyzing those values using one or more AI models to generate predicted structural loads on the rotorcraft components. The predicted structural loads can be used to determine individualized estimated fatigue lives for the rotorcraft components and to generate, based on those individualized estimated fatigue lives, individualized maintenance recommendations for the rotorcraft components.

Because the predicted dynamic load is based on actual usage information (e.g., the operational condition information), the fatigue life of those components also can be estimated based on actual usage data. Furthermore, because the individualized estimated fatigue life of the components is based on actual usage data, a customized maintenance plan with individualized maintenance recommendations can be generated, which may reduce maintenance burden.

Continuing with the rotorcraft example, in certain embodiments, the AI model, which may be a deep learning model for example, may be trained using operation control information collected from sensors during test flights, along with associated test load signals, for selected time windows. In certain embodiments, for training the AI model, the test load signals for the selected time windows may be converted from the time domain to the frequency domain, which may result in a trained AI model that predicts loads in the frequency domain. This may reduce AI model complexity and increase prediction accuracy by predicting load major spectra in frequency domain for each designed data window size, as frequency domain data generally reduces a number of data points. The predicted load may be converted back to the time domain for further process, including generating the individualized estimated fatigue life and maintenance recommendation for components.

This disclosure primarily describes an example of a rotorcraft (e.g., helicopter); however, this disclosure may apply to any suitable type of aircraft or even other types of vehicles or other machines for which predicting structural loads and/or estimating component fatigue life may be useful.

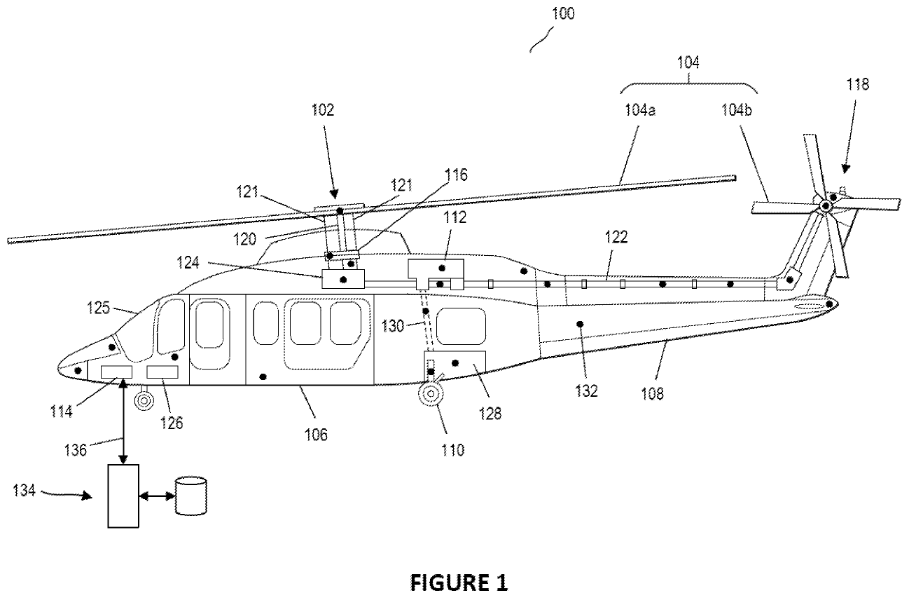

FIG. 1 illustrates aspects of an example rotorcraft 100, according to certain embodiments. It should be appreciated that some of teachings from rotorcraft 100 may apply to aircraft other than rotorcraft, such as airplanes, tilt rotor aircraft, unmanned aircraft, and the like. Rotorcraft 100 includes a main rotor system 102, rotor blades 104, a fuselage 106 (also referred to as an airframe), a tail section 108, landing gear 110, multiple engines 112, and one or more aircraft computer systems 114.

Main rotor system 102 includes main rotor blades 104a. The pitch of each main rotor blade 104a may be controlled by a swashplate 116 to selectively control the attitude, altitude and movement of rotorcraft 100. Swashplate 116 may be used to collectively and/or cyclically change the pitch of main rotor blades 104a.

Rotorcraft 100 also has an anti-torque system, which may include a tail rotor, no-tail-rotor (NOTAR), or dual main rotor system. In the illustrated example, rotorcraft 100 includes tail rotor 118 having tail rotor blades 104b. The pitch of each tail rotor blade 104b may be collectively changed to vary thrust of the anti-torque system, providing directional control of rotorcraft 100. The pitch of tail rotor blades 104b may be changed by one or more tail rotor actuators.

Power is supplied to main rotor system 102 to rotate main rotor blades 104a and/or to tail rotor 118 to rotate tail rotor blades 104b using one or more engines 112. For example, engines 112 may supply an output (e.g., torque) to rotor mast 120 via drive shaft 122, which is mechanically and operatively coupled to main rotor system 102 through a main rotor transmission 124, to rotate main rotor blades 104a. As another example, engines 112 may supply an output (e.g., torque) to tail rotor 118 via drive shaft 122, which is mechanically and operatively coupled to tail rotor 118 through a tail rotor transmission, to rotate tail rotor, blades 104b. Engines 112, rotor mask 120, and drive shaft 122 may form at least a portion of what may be referred to as a powertrain of rotorcraft 100, and the powertrain may be configured to rotate main rotor blades 104a and/or tail rotor blades 104b.

Although this disclosure contemplates engines 112 being implemented in any suitable manner, in certain embodiments, engines 112 may be gas turbine (e.g., turboshaft) engines. In a particular example, rotorcraft 100 includes a pair of engines 112, which may be referred to as twin turbine engines.

Fuselage 106 represents the body of rotorcraft 100 and is coupled to the powertrain such that the powertrain and rotor blades 104 move fuselage 106 through the air during operation. Fuselage 106 includes a cockpit 125, which includes displays, controls, and instruments. Although rotorcraft 100 is depicted as having certain illustrated features, rotorcraft 100 may have a variety of implementation-specific configurations. For example, in certain embodiments, cockpit 125 is configured to accommodate a pilot or a pilot and co-pilot (and/or additional crew), as illustrated. This disclosure contemplates, however, that rotorcraft 100 may be operated remotely, in which case cockpit 125 could be configured as a fully functioning cockpit to accommodate a pilot (and possibly a co-pilot as well) to provide for greater flexibility of use, or could be configured with a cockpit having limited functionality (e.g., a cockpit with accommodations for only one person who would function as the pilot operating perhaps with a remote co-pilot or who would function as a co-pilot or back-up pilot with the primary piloting functions being performed remotely). In yet other embodiments, rotorcraft 100 could be configured as an unmanned vehicle, in which case cockpit 125 could be eliminated entirely to save space and cost.

Landing gear 110 (e.g., wheels, rails, or the like) supports rotorcraft 100 when rotorcraft 100 is grounded. Tail section 108 represents the tail section of rotorcraft 100 and is connected to tail rotor 118/tail rotor blades 104b. The tail section 108 may have other flight control devices such as horizontal or vertical stabilizers, rudder, elevators, or other control or stabilizing surfaces that are used to control or stabilize flight of rotorcraft 100. The powertrain and tail rotor blades 104b may collectively provide thrust in the same direction as the rotation of main rotor blades 104a, so as to counter torque effects created by main rotor blades 104a.

Rotorcraft 100 includes flight control devices operable to change the flight characteristics of rotorcraft 100. The flight control devices can be part of the powertrain, main rotor system 102, rotor blades 104, fuselage 106, and the like. The flight control devices include mechanical and/or electrical systems operable to change, e.g., the positions or angle of attack of rotor blades 104, the power output of engines 112, and the like. In certain embodiments, the flight control devices include a swashplate 116 or other device for collectively or cyclically controlling the pitch of each of main rotor blades 102a to selectively control direction, thrust, and lift of rotorcraft 100. In certain embodiments, the flight control devices include a tail rotor actuator for collectively controlling the pitch of tail rotor blades 104b to selectively control yaw of rotorcraft 100. In certain embodiments, the flight control devices include an engine control computer for selectively varying the power output of engines 112. Other examples of flight control devices include horizontal or vertical stabilizers, rudder, elevators, or other control or stabilizing surfaces that are used to control or stabilize flight of rotorcraft 100.

Aircraft computer systems 114 include any of the computers that operate to collect and/or analyze data related to rotorcraft 100 or its environment, control operation of one or more components of rotorcraft 100, or perform other suitable operations. Aircraft computer systems 114 may include flight control computers, cockpit display unit(s), the aforementioned engine control computers, and/or other processing devices. In certain embodiments, aircraft computer systems 114 are operable to collect data about, or control flight of, rotorcraft 100. Rotorcraft 100 may be a fly-by-wire (FBW) rotorcraft, and aircraft computer systems 114 include flight control computers operable to execute one or more control laws (CLAWS) that control flight of rotorcraft 100. For example, aircraft computer systems 114 can send electrical signals to engines 112, the actuators for swashplate 116, the tail rotor actuators, or the like to control flight of rotorcraft 100. Aircraft computer systems 114 may be operable to perform sensor data collection and analysis as part of a health and usage monitoring system (HUMS), a flight control system, a sensor system, a monitoring system, or the like.

Although aircraft computer systems 114 are shown to be a part of rotorcraft 100, this disclosure contemplates some or all of the processing devices that make up aircraft computer systems 114 being located on or remote from rotorcraft 100. In the case of some or all of the processing devices that make up aircraft computer systems 114 being located remote from rotorcraft 100, such processing devices may communicate with rotorcraft 100 (e.g., processing devices located on rotorcraft 100) using a suitable wireless communication technology.

Rotorcraft 100 includes power supply system 126, which may include one or more batteries of any suitable type. Power supply system 126 is configured to provide electrical power to power electrical components of rotorcraft 100, such as to aircraft computer systems 114 and/or other flight control devices (e.g., switches, actuators, etc.).

Rotorcraft 100 includes fuel system 128, which may include one or more fuel cells/tanks, one or more fuel lines 130, and other components for distributing fuel to other appropriate components of rotorcraft 100, such as to engines 112.

Rotorcraft 100 include sensors 132 positioned throughout rotorcraft 100. Sensors 132 are shown in FIG. 1 as solid-filled black dots, with only one instance labeled to avoid overcrowding FIG. 1 with additional labels. Although sensors 132 are shown in particular locations of rotorcraft 100, sensors 132 may be positioned at any suitable locations of rotorcraft.

Sensors 132 are configured to record sensor measurements for one or more operating condition parameters associated with rotorcraft 100. Sensors 132 may be aircraft sensors and may take sensor readings and generate one or more sensor signals such as electrical signals, data elements, or the like, that indicate one or more operational conditions. For example, a sensor 132 may be a vibration sensor near an engine, gear set or transmission that detects vibrations from the local components. In another example, a sensor 132 may be a voltage sensor or current detector that detects the voltage or current drawn by an electrical operating element such as a pump or a motor. As another example, a sensor 132 may be a pressure or flow sensor that detects the pressure of a hydraulic line or fuel line, the flow rate of a fluid such as fuel, coolant, oil hydraulic fluid, or the like.

Sensors 132 may produce new measurements on a regular or continuous basis, or at any other suitable interval.

Sensors 132 may include, as examples, any suitable combination of pressure sensors, temperature sensors, force sensors, torque sensors, speed sensors, position and displacement sensors, level sensors, proximity sensors, flow sensors, accelerometers, gyroscopes, pitot probes, radar sensors, Angle-of-Attack (AoA) sensors, altimeter sensors, smoke-detection sensors, global positioning system (GPS) sensors, cloud-height sensors, visibility sensors, wind sensors, dew-point sensors, relative humidity sensors, lightning or thunder-storm sensors, precipitation-type sensors, precipitation-occurrence sensors, freezing-rain sensors, precipitation-accumulation sensors, snow-depth sensors, and/or day/night sensors. Aircraft also may include sensors related to operation of particular system functions such as engines, doors and slides, cabin and cargo environmental controls, flight decks and flight controls, landing gears, wheels and brakes, fuel, hydraulic and pneumatic systems, and wired and wireless network-connectivity systems.

In a particular example, at least some of sensors 132 on rotorcraft 100 may be accelerometers, and measurements made by at least certain of those accelerometers may provide main/tail rotor track and balance/ride quality monitoring, gearbox monitoring, engine/combining gearbox (cobox or c-box) monitoring, tail rotor drive system monitoring, and/or other suitable types of monitoring. As just one example, accelerometers may measure/monitor vibration at particular location of rotorcraft 100.

The types of sensor measurement made by sensors 132 and/or interpreted from sensor measurements may include pressure altitude (ft), computed airspeed (kt), altitude rate (ft/min), static air temperature (Celsius), pitch angle (deg), roll angle (deg), selected torque (Q) engine (ENG) 1 (%), selected Q ENG 2 (%), rotor RPM (%), FCC1 cyclic FA position (%), FCC1 Cyclic Lat position (%), FCC1 Pedal position (%), body longitudinal acceleration (g), body normal acceleration (g), and body lateral acceleration (g).

Sensors 132 may vary in type depending on the particular measurements being made by a given sensor 132 and the associated capabilities of a given sensor 132. For example, certain sensors 132 may simply record and report measurements, while other sensors 132 may have additional process abilities for processing measurements.

Although rotorcraft 100 is illustrated and described as including a particular number of sensors 132, rotorcraft 100 may include any suitable number of sensors 132, including one or more. Additionally, although rotorcraft 100 is illustrated and described as including particular types of sensors 132, rotorcraft 100 may include any suitable types of sensors 132 in any suitable combination. Additionally, this disclosure contemplates one or more sensors 132 being remote from rotorcraft 100 and being able to detect information about rotorcraft 100 remotely.

Rotorcraft 100 also may communicate with one or more external computer systems 134. That is, computer system 114 may be located on board rotorcraft 100, and computer system 134 may be located off board rotorcraft 100. Computer system 134 may include any suitable processing device. In certain embodiments, computer system 134 is a server system. Computer system 134 may include a storage module, which may be implemented, for example, as a database. The database may be a relational database, such as a structured query language (SQL) database, or may be a non-relational database, such as a key-value store.

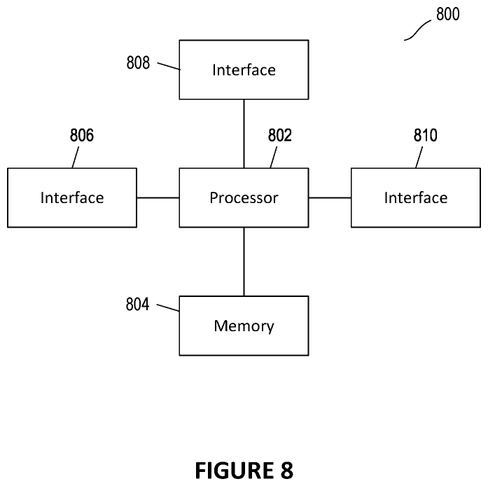

Computer system 114 and computer system 134 may be implemented using any suitable combination of hardware, firmware, and software. In certain embodiments, aircraft computer system 114 and computer system 134 may individually or collectively be implemented using a computer system such as the example described below with reference to FIG. 8.

Aircraft computer system 114 and computer system 134 may communicate via one or more links 136. Links 136 may include any suitable combination of wired or wireless communication links, such as any suitable combination of an Ethernet connection, a Wi-Fi connection, a cellular connection, a satellite link, an aircraft communications addressing and reporting system (ACARS) link, or the like.

Aircraft computer system 114 and/or computer system 134 may be configured to predict structural load information for certain rotorcraft components of rotorcraft 100 using actual operating condition information (e.g., flight parameter values) captured from sensors 132 during operation of rotorcraft 100 and analyzing the actual operating condition information using one or more AI models to generate predicted structural load information for the rotorcraft components. The predicted structural load information can be used to determine individualized estimated fatigue lives for the rotorcraft components and to generate, based on those individualized estimated fatigue lives, individualized maintenance recommendations for the rotorcraft components.

Because the predicted dynamic load is based on actual usage information (e.g., operational condition information), the fatigue life of those components also can be estimated based on actual usage data. Furthermore, because the individualized estimated fatigue life of the components is based on actual usage data, a customized maintenance plan with individualized recommendations can be generated, which may reduce maintenance burden.

The AI model can incorporate machine learning techniques, such as deep learning techniques, to analyze the actual operating condition information, which may allow the predictions of the load information to improve over time. In general, machine learning can include the study of computer algorithms that improve automatically through experience and by the use of data. Machine learning algorithms can build a model based on sample data, known as “training data,” to make predictions or decisions without being explicitly programmed to do so.

Continuing with the rotorcraft example, in certain embodiments, the AI model, which may be a deep learning model for example, may be trained using operation control information from collected from sensors during test flights, along with associated test load signals, for selected time windows. In certain embodiments, for training the AI model, the test load signals for the selected time windows may be converted from the time domain to the frequency domain, which may result in a trained AI model that predicts loads in the frequency domain. This may reduce AI model complexity and increase prediction accuracy by predicting load major spectra in frequency domain for each designed data window size, as frequency data generally reduces a number of data points. The predicted load may be converted back to the time domain for further process, including generating the individualized estimated fatigue life and maintenance recommendation for components.

This disclosure contemplates monitoring any suitable rotorcraft components of rotorcraft 100. Embodiments of this disclosure may be used to predict structural load information estimate fatigue life of any suitable component, combination of components, and/or operational characteristics of rotorcraft 100. As just a few example, embodiments of this disclosure may be used to predict structural load information and estimate fatigue life of a fuselage, rotor blades, a blade beam, a blade chord, blade torsion, mast bending, a blade beam, pitch link, tail rotor control tube, H-Stab Spar Tube Beam bending, vertical fin bending, T/B vertical bending, longitudinal vertical control tube, lateral vertical control tube, collective tube, engine mount tube, roof beam, pylon restraint spring, and/or any other suitable components. In certain embodiment, the predicted structural load information and fatigue estimates may cover all three major sections of a rotorcraft: main rotor, tail rotor, and fixed systems.

Sensors 132 may measure values for operational condition parameters related to monitored components (components for which predicting the structural load and estimating an individualized fatigue life are desired) of rotorcraft 100, and may report measured data as signals to an appropriate computer system. Sensors 132 can include any of the sensors described herein, as well as other types of sensors, in any suitable combination.

One or more sensors 132 may provide measurements that may assist in predicting structural load information for a particular rotorcraft component, and certain sensors 132 may provide measurements that may assist in predicting structural load information for multiple rotorcraft components. A mapping of sensors 132 to rotorcraft components may be stored to facilitate determining which sensor measurements should be analyzed when training a particular AI model for a particular component and when processing actual operating condition information to predict structural load information for a component. In certain embodiments, a separate AI model may be trained for each component being monitored, as the particular sensor measurements relevant to predicting structural load information for a component may vary from component to component.

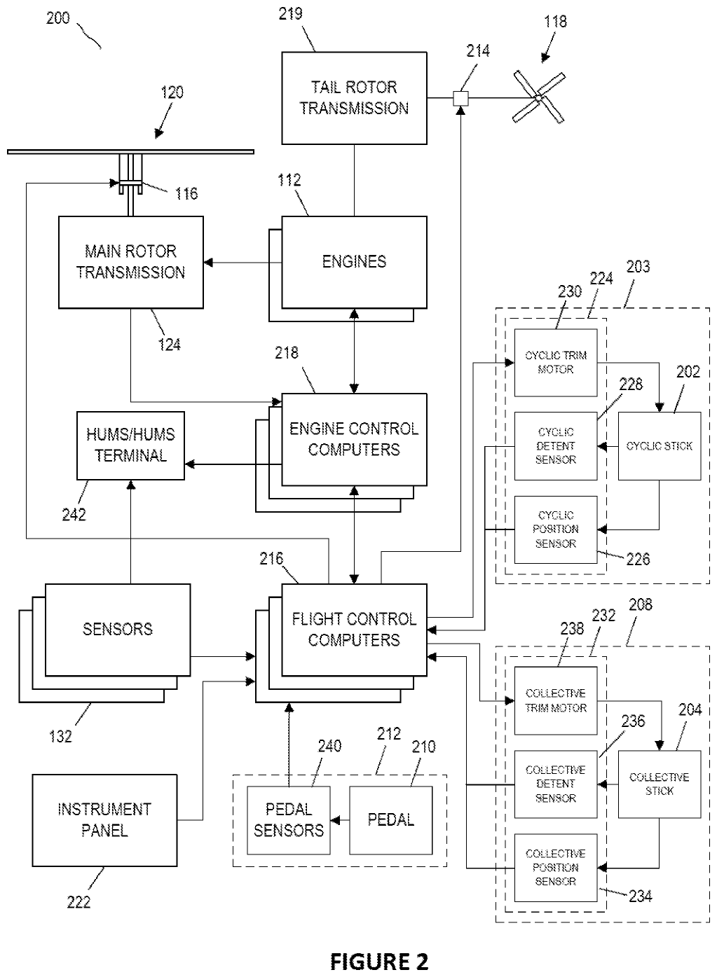

FIG. 2 illustrates a representation of a flight control system 200 for a rotorcraft (e.g., rotorcraft 100), according to certain embodiments. Flight control system 200 may implement some or all of a fly-by-wire (FBW) system.

A pilot may manipulate one or more pilot flight controls to control flight of rotorcraft 100. The pilot flight controls may include manual controls such as a cyclic stick 202 in a cyclic control assembly 203, a collective stick 204 in a collective control assembly 208, and pedals 210 in a pedal control assembly 212. Inputs provided by the pilot to the pilot flight controls may be transmitted mechanically and/or electronically (e.g., via flight control system 200) to flight control devices by the flight control system 200. Flight control devices may represent devices operable to change flight characteristics of rotorcraft 100. Flight control devices on rotorcraft 100 may include mechanical and/or electrical systems operable to change the positions or angle of attack of rotor blades 104 or to change the power output of the engines 112, as examples. Flight control devices include systems such as the swashplate 116, tail rotor actuator 214, and systems operable to control the engines 112. Flight control system 200 may adjust the flight control devices independently of the flight crew in order to stabilize rotorcraft 100, reduce workload of the flight crew, and the like.

Flight control system 200 may include flight control computers (FCCs) 216, engine control computers (which also may be referred to as engine control computer units, or engine control computers) 218, and sensors 132, which collectively adjust the flight control devices and monitor rotorcraft 100 during operation.

Flight control system 200 includes one or more flight control computers 216. In certain embodiments, multiple flight control computers 216 are provided for redundancy. One or more modules within flight control computers 216 may be partially or wholly embodied in any suitable combination of hardware, firmware, and software for performing any operations described herein. In embodiments where flight control system 200 is an FBW flight control system, flight control computers 216 may analyze pilot inputs and dispatch corresponding commands to engine control computers 218, tail rotor actuator 214, and/or actuators for the swashplate 116. Further, flight control computers 216 may be configured by and receive input commands from the pilot controls through sensors associated with each of the pilot flight controls. The input commands may be received by measuring the positions of the pilot controls. Flight control computers 216 also may control tactile cues to the pilot controls or display information in instruments on, for example, an instrument panel 222.

Flight control system 200 includes one or more engine control computers 218, which also may be referred to as engine control computing units, or ECCUs. In certain embodiments, a respective engine control computer 218 is provided for each engine 112. One or more modules within engine control computers 218 may be partially or wholly embodied in any suitable combination of hardware, firmware, and software for performing any operations described herein. Engine control computers 218 control engines 112. For example, engine control computers 218 may vary the output power of engines 112 to control the rotational speed of main rotor blades 104a through main rotor transmission 124 and tail rotor blades 104b through tail rotor transmission 219. Engine control computers 218 may control the output power of engines 112 according to commands from flight control computers 216, feedback such as measured RPM of main rotor blades 104a, or other suitable input.

Cyclic control assembly 203 is connected to a cyclic trim assembly 224 having one or more cyclic position sensors 226, one or more cyclic detent sensors 228, and one or more cyclic actuators or cyclic trim motors 230. Cyclic position sensors 226 measure the position of cyclic stick 202. In certain embodiments, cyclic stick 202 is a single control stick that moves along two axes and permits a pilot to control pitch, which is the vertical angle of the nose of rotorcraft 100 and roll, which is the side-to-side angle of rotorcraft 100. In certain embodiments, cyclic control assembly 203 has separate cyclic position sensors 226 that measure roll and pitch separately. Cyclic position sensors 226 for detecting roll and pitch generate roll and pitch signals, respectively, (sometimes referred to as cyclic longitude and cyclic latitude signals, respectively) which are sent to flight control computers 216, which controls the swashplate 116, engines 112, tail rotor 118, or related flight control devices.

Cyclic trim motors 230 are connected to flight control computers 216, and receive signals from flight control computers 216 to move cyclic stick 202. In certain embodiments, flight control computers 216 determine a suggested cyclic stick position for cyclic stick 202 according to one or more of the collective stick position; the pedal position; the speed, altitude, and attitude of rotorcraft 100; the engine RPM, engine temperature, main rotor RPM, engine torque, or other rotorcraft system or flight conditions; or according to a predetermined function selected by the pilot. The suggested cyclic stick position is a position determined by flight control computers 216 to give a desired cyclic action. In certain embodiments, flight control computers 216 send a suggested cyclic stick position signal indicating the suggested cyclic stick position to cyclic trim motors 230. While flight control computers 216 may command cyclic trim motors 230 to move cyclic stick 202 to a particular position (which would in turn drive actuators associated with swashplate 116 accordingly), cyclic position sensors 226 detect the actual position of cyclic stick 202 that is set by cyclic trim motors 230 or input by the pilot, allowing the pilot to override the suggested cyclic stick position. Cyclic trim motor 230 is connected to cyclic stick 202 so that the pilot may move cyclic stick 202 while the trim motor is driving cyclic stick 202 to override the suggested cyclic stick position. Thus, in certain embodiments, flight control computers 216 receive a signal from cyclic position sensors 226 indicating the actual cyclic stick position, and do not rely on the suggested cyclic stick position to command swashplate 116.

Similar to cyclic control assembly 203, collective control assembly 208 is connected to a collective trim assembly 232 having one or more collective position sensors 234, one or more collective detent sensors 236, and one or more collective actuators or collective trim motors 238. Collective position sensors 234 measure the position of collective stick 204 in collective control assembly 208. In certain embodiments, collective stick 204 is a single control stick that moves along a single axis or with a lever type action. A collective position sensor 234 detects the position of collective stick 204 and sends a collective position signal to flight control computers 216, which controls engines 112, swashplate actuators, or related flight control devices according to the collective position signal to control the vertical movement of rotorcraft 100. In certain embodiments, flight control computers 216 may send a power command signal to engine control computers 218 and a collective command signal to the main rotor or swashplate actuators so that the angle of attack of the main blades is raised or lowered collectively, and the engine power is set to provide the needed power to keep the main rotor RPM substantially constant.

Collective trim motor 238 is connected to flight control computers 216, and receives signals from flight control computers 216 to move collective stick 204. Similar to the determination of the suggested cyclic stick position, in certain embodiments, flight control computers 216 determine a suggested collective stick position for collective stick 204 according to one or more of the cyclic stick position; the pedal position; the speed, altitude, and attitude of rotorcraft 100; the engine RPM, engine temperature, main rotor RPM, engine torque, or other rotorcraft system conditions or flight conditions; or according to a predetermined function selected by the pilot. Flight control computers 216 generate the suggested collective stick position and send a corresponding suggested collective stick signal to collective trim motors 238 to move collective stick 204 to a particular position. Collective position sensors 234 detect the actual position of collective stick 204 that is set by collective trim motor 238 or input by the pilot, allowing the pilot to override the suggested collective stick position.

Pedal control assembly 212 has one or more pedal sensors 240 that measure the position of pedals 210 or other input elements in the pedal control assembly 212. In certain embodiments, pedal control assembly 212 is free of a trim motor or actuator, and may have a mechanical return element that centers pedals 210 when the pilot releases pedals 210. In other embodiments, pedal control assembly 212 has one or more trim motors that drive a pedal 210 to a suggested pedal position according to a signal from flight control computers 216. Pedal sensors 240 detect the position of pedals 210 and sends a pedal position signal to flight control computers 216, which controls the tail rotor 118 to cause rotorcraft 100 to yaw or rotate around a vertical axis.

Cyclic and collective trim motors 230 and 238 may drive cyclic stick 202 and collective stick 204, respectively, to suggested positions. Cyclic and collective trim motors 230 and 238 may drive cyclic stick 202 and collective stick 204, respectively, to suggested positions, but this movement capability may also be used to provide tactile cueing to a pilot. Additionally, cyclic control assembly 203, collective control assembly 208, and/or pedal control assembly 212 each may have one or more detent sensors that determine whether the pilot is handling a particular control device. Flight control computers 216 may provide different default control or automated commands to one or more flight systems based on the detent status of a particular stick (cyclic stick 202 or collective stick 204) or pilot control.

Sensors 132 are in communication with flight control computers 216, HUMS 242, and/or any other suitable components of rotorcraft 100 or computer system 134. Sensors 132 may include sensors for monitoring operation of the rotorcraft, providing pilot data, providing operational data, or the like, and sensors 132 may include sensors for measuring a variety of rotorcraft systems, flight parameters, environmental conditions, and the like. For example, sensors 132 may include sensors for gathering flight data, and may include sensors for measuring airspeed, altitude, attitude, position, orientation, temperature, airspeed, vertical speed, and the like. Sensors 132 may include sensors relying upon data or signals originating external to rotorcraft 100, such as a global positioning system (GPS) sensor, a VHF Omnidirectional Range sensor, Instrument Landing System (ILS), and the like. Sensors 132 may include sensors for reading operational data such as vibration, device rotational speed, electrical operating characteristics, fluid flows, or the like. Sensors 132 may include any of the sensors described throughout this disclosure and/or any other suitable sensors in any suitable combination.

Flight control system 200 may include HUMS 242 or a HUMS terminal. In certain embodiments, HUMS 242 collects data from flight control system 200 elements for storage and later download, analysis, or the like. In certain embodiments, HUMS 242 may be connected to or otherwise capable of communicating with one or more sensors 132, flight control computers 216, engine control computers 218, standalone sensors, sensors integrated into HUMS 242, or other system components, or a combination of components. In certain embodiments, HUMS 242 may be separate from flight control computers 216, and may be implemented as a standalone system that communicates with, but that is operationally separate from, other elements of flight control system 200. HUMS 242 may be a terminal that stores raw data from one or more aircraft components, and provides the raw data to a server for interpretation and analysis. Additionally or alternatively, HUMS 242 may interpret raw data to determine one or more condition indicators for a server or other system that analyzes or displays the data. Additionally or alternatively, HUMS 242 may analyze the raw data or condition indicators to determine a predicted load on a component of rotorcraft 100, determine an estimated fatigue life of a component of rotorcraft 100 that is individualized for the component, generate a maintenance plan for rotorcraft 100 (including an individualized maintenance recommendation for the component), and may display or indicate the interpreted data, a warning, a system status, or like, on instrument panel 222, on a dedicated display, through an audible warning, within another display such as a flight director display, though a tactile feedback system, or the like.

HUMS 242 may use data from sensors 132 to determine an operating condition such as vibration. For example, HUMS 242 may use a combination of vibration data and rotational speed data to generate synchronous vibration data or other transformed data types, which may be analyzed to determine a predicted load on a component of rotorcraft 100, determine an estimated fatigue life of a component of rotorcraft 100 that is individualized for the component, generate a maintenance plan for rotorcraft 100 (including an individualized maintenance recommendation for the component) for specific components associated with the vibration data.

In certain embodiments, flight control computers 216, engine control computers 218, and HUMS 242 may be some or all of the processing devices of aircraft computer systems 114.

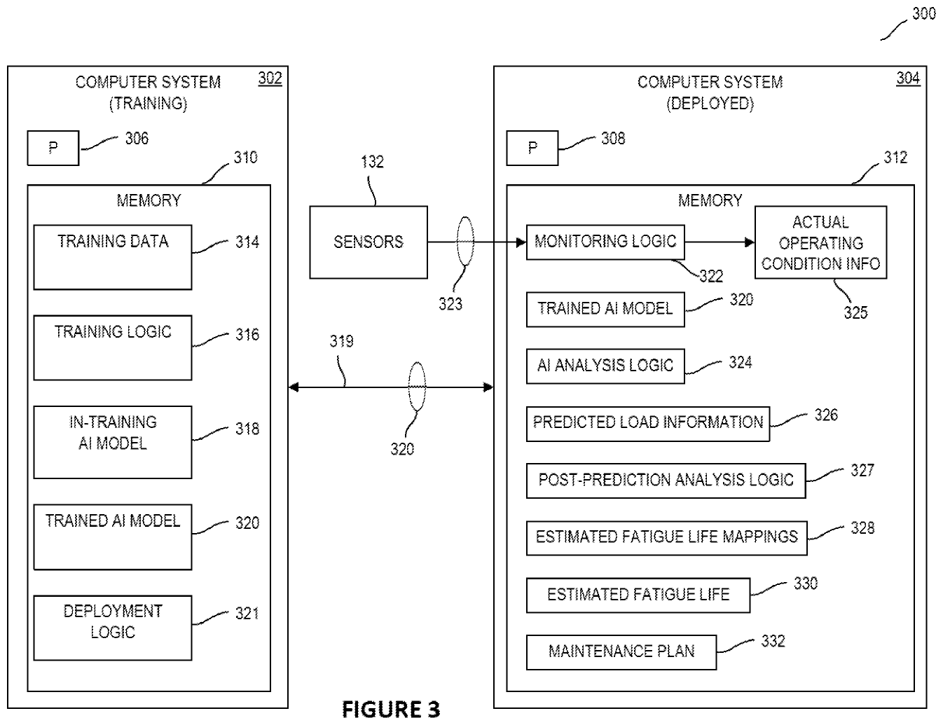

FIG. 3 illustrates an example system 300 for predicting structural load information and estimating vehicle component fatigue, according to certain embodiments. In the illustrated example, system 300 includes a computer system 302, a computer system 304, and sensors 132. For purposes of this example, computer system 302 is described as a training computer system that, during a training phase, trains an AI model for predicting structural load information for a vehicle component, and computer system 304 is described as a deployed computer system in which the trained AI model is deployed for processing actual data from sensors 132 for predicting structural load information of a vehicle component on a vehicle deployed for actual use and associated operations. For purposes of the remainder of this example, it will be assumed that the vehicle is rotorcraft 100.

In certain embodiments, computer system 302, which performs the AI model training in this example, may correspond to computer system 134 of FIG. 1 or to another computer system external to rotorcraft 100; however, this disclosure contemplates computer system 302 being at any suitable location, including on rotorcraft 100. In certain embodiments, computer system 304, which performs processing of actual live data using the trained AI model, may correspond to a computer system 114 on rotorcraft 100 (as shown in FIG. 1) or to another computer system on rotorcraft 100. For example, computer system 304 could be (or be a part of) HUMS 242, flight control computers 216, or another computer system on rotorcraft 100. This disclosure, however, contemplates computer system 304 being at any suitable location, including partially or wholly on board rotorcraft 100 or off board rotorcraft 100.

Furthermore, although computer systems 302 and 304 are illustrated and described separately for purposes of this example, computer systems 302 and 304 could be the same computer systems. In other words, in certain embodiments, the same computer system could perform both the training of the AI model and the processing of actual live data using the AI model, if appropriate. Furthermore, this disclosure contemplates subdividing the operations among computer systems differently than shown and described. As just one example, a computer system on board rotorcraft 100 may collect the data from sensors 132 and then communicate that data (in raw format or with any suitable pre-processing) to another computer system (on board or off board rotorcraft 100) for analysis using the trained AI model and additional operations.

Computer system 302 and computer system 304 include processor 306 and processors 308, respectively. Processors 306 and 308 may be any component or collection of components adapted to perform computations and/or other processing-related tasks. Processors 306 and 308 can be, for example, a microprocessor, a microcontroller, a control circuit, a digital signal processor, a field-programmable gate array (FPGA), an application-specific integrated circuit (ASIC), a system-on-chip (SoC), a graphics processing unit (GPU), or combinations thereof. Furthermore, each of processor 306 and 308 may include any suitable number of processors, or multiple processors may collectively form a single processor 306 or 308.

Computer system 302 and computer system 304 may include memory 310 and memory 312, respectively. Memories 310 and 312 may include any suitable combination of volatile memory, nonvolatile memory, and/or virtualizations thereof. Memories 310 and 312 may include data structures used to organize and store all or a portion of the stored data. In general, memories 310 and 312 can store any data used by or accessible to computer systems 302 and 304, respectively. In the illustrated example, memory 310 stores training data 314, training logic 316, in-training AI model 318, trained AI model 320, and deployment logic 321. Additionally, in the illustrated example, memory 312 stores monitoring logic 322, trained AI model 320, AI analysis logic 324, predicted fatigue load 326, post-prediction analysis logic 327, estimated fatigue life mapping 328, estimated fatigue life 330, and maintenance plan 332.

Turning to computer system 302, training data 314 may include data to be used for training in-training AI model 318 to generate trained AI model 320. Training data 314 may include test operating condition information (e.g. test flight parameter measurements) and structural load spectra collected from test flights. In other words, training data 314 may include data gathered from historical rotorcraft operation test data.

In certain embodiments, training data 314 may include test operating condition information for a test operating condition of a test rotorcraft. The test operating condition information may correspond to sensor measurements associated with a rotorcraft component that will be monitored during actual usage. The test operating condition may correspond to an operating condition parameter that will be monitored during actual usage. For example, training data may include test data (e.g., data signals) for one or more test parameters collected from sensors during actual or simulated test flights. At least a portion of the one or more parameters may correspond to the parameters that will be analyzed by the trained AI model during deployment for analysis of actual data. The data collected from these test flights may provide historical data for training the AI model.

In certain embodiments, training data 314 also includes test load information for a training operating condition of one or more test rotorcraft. For example, the test load information may include a test load signal in an initial time domain format. As described in greater detail below, training data 314 may additionally or alternatively store the test load signal in a frequency domain format.

Training logic 316 may include the logic for executing a training phase to train in-training AI model 318 using training data 314 to generate trained AI model 320. In operation of an example embodiment, training logic 316 may access training data 314 for a selected time window and train in-training AI model 318 using the training data.

In certain embodiments, training data 314 is in a time domain format. Data in a time domain format tends to include a large number of data points that can be difficult to manage and process, making it difficult to identify features during training. In certain embodiments, at least a portion of training data 314 is converted to a frequency domain format, which may reduce, possibly significantly, the number of data points being analyzed.

In certain embodiments, training logic 316 converts, prior to training in-training AI model 318 using training data 314, at least a portion of training data 314 to a frequency domain, such that in-training AI model 318, and ultimately trained AI model 320, are trained to predict structural load information in the frequency domain. For example, training logic may convert the test load signal from the time domain to the frequency domain. Training logic 316 may use any suitable transform function or other technique to transform at least a portion of training data from the time domain to the frequency domain. As just a few examples, the transform function may include the discrete Fourier transform, the fast Fourier transform, or another suitable algorithm for transforming the signal in the time domain to the frequency domain.

This disclosure contemplates any suitable pre-processing being performed on training data prior to using the training data to train in-training AI model 318. For example, such preprocessing may include any suitable combination of signal preparation (e.g., filtering and noise removal, and level normalization), feature engineering (spectrum analysis, cepstral analysis, peak detection, and zero-crossing detection), or any other suitable pre-processing.

Thus, in certain embodiments, trained AI model 320 is trained to output a signal in the frequency domain. For example, trained AI model 320 may be trained to output in a frequency domain a signal representing predicted load information according to a given set of values for input parameters (e.g., operating condition information for operating condition parameters).

Trained AI model 320 is a version of the AI model following training by training logic 316 using training data 314. Trained AI model 320 is ready for deployment for use with during actual operation of rotorcraft 100. As just one particular example, trained AI model 320 may have been trained to predict load information for a pitch link 121 (see FIG. 1) in the frequency spectrum using operating condition information from each revolution and the type of learning (e.g., deep learning) implemented by trained AI model 320.

Deployment logic 321 may deploy trained AI model 320 for use in evaluating actual parameters associated with actual operation of rotorcraft 100. For example, deployment logic 321 may transmit a copy of trained AI model 320 to computer system 304 via links 319. Links 319 may include any suitable combination of wired or wireless communication links, such as any suitable combination of an Ethernet connection, a Wi-Fi connection, a cellular connection, a satellite link, an ACARS link, or the like.

Trained AI model 320 may be retrained, if appropriate. For example, it may be desirable to retrain AI model 320 periodically, which may help maintain and/or improve the performance of AI model 320 at providing relatively accurate predicted load information. Trained AI model 320 may be retrained using entirely new training data, modifications to existing training data 314, modifications to aspects of AI model 320 (e.g., to one or more layers of AI model 320), or any other suitable information.

Turning to computer system 304, monitoring logic 322 may monitor sensors 132 for output signals 323. In certain embodiments, sensors 132 are configured to report output signals 323 to monitoring logic 322 automatically. Additionally or alternatively, monitoring logic 322 may poll sensors 132 for output signals 323. Output signals from sensors 132 may be sensor measurements associated with an operating condition parameter that reflects an operating condition associated with a rotorcraft component. For example, measurement data from sensors 132 may be real-time measurements taken by sensors 132 during operation of rotorcraft 100.

Monitoring logic 322 may store output signals 323 as actual operating condition information 325. Actual operating condition information 325 for sensors 132 may include values for operating condition parameters associated with actual operation of rotorcraft 100. As an example, a particular sensor 132 may be an accelerometer in proximity to collective tube. Measurements (sensor measurements) made by the accelerometer (sensor) may detect vibration (operating condition/operating condition parameter) near the collective tube (rotorcraft component), and the vibration measurements may be output as operating condition information 325 or for derivation of an operating condition information 325 from the vibration measurements.

Actual operating condition information 325 may be the raw sensor data of output signal 323 of sensors 132 or data derived from the raw sensor data. For example, in the case of data derived from the raw sensor data, sensors 132 and/or monitoring logic 322 may process the raw sensor data to determine actual operating condition information. This disclosure contemplates any suitable pre-processing being performed on the actual data signal prior to submitting the actual data signal to trained AI model 320. For example, such preprocessing may include any suitable combination of signal preparation (e.g., filtering and noise removal, and level normalization), feature engineering (spectrum analysis, cepstral analysis, peak detection, and zero-crossing detection), or any other suitable pre-processing.

In certain embodiments, output data 323 from a particular sensor 132 may be used to determine respective predicted load information of multiple rotorcraft components. Output signals 323 from multiple sensors 132 may be relevant to determine respective predicted load information of multiple rotorcraft components.

Monitoring logic 322 may store actual operating condition information 325 in any suitable manner. In certain embodiments, the stored actual operating condition information may be indexed by a sensor identifier identifying the sensor 132 from which the actual operating condition information was derived, an identification of the one or more rotorcraft components being monitored using actual operating condition information from measurements of the sensor 132, timestamp information, or any other suitable information for indexing actual operating condition information.

AI analysis logic 324 may cause trained AI model 320 to analyze actual operating condition information 325 to generate predicted load information 326 for the rotorcraft component. For example, the input to trained AI model 310 may include one or more signals including actual operating condition information for one or more sensors 132 that are used to monitor a rotorcraft component. AI model 320 may process the one or more signals and generate an output signal that comprises predicted load information 326 for the rotorcraft component. Predicted load information 326 may be output as a signal. In certain embodiments, the output signal expresses the predicted load information 326 as pounds (lbs.), though any suitable unit of measure may be used.

Post-prediction analysis logic 327 may analyze predicted fatigue loading information 326, which may be in the time domain in certain embodiments, to generate an estimated fatigue life 330 of a component. For example, computer system 304 may store (in memory 312) or otherwise have access to estimated fatigue life mappings 328. Estimated fatigue life mappings 328 may map particular values for predicted fatigue load information 326 to particular fatigue life estimations. Based on those mappings, post-prediction analysis logic 327 may determine an estimated fatigue life 330 for the vehicle component that is individualized for the rotorcraft component according to actual usage information of rotorcraft 100 and processing performed using trained AI model 320.

In certain embodiments, post-prediction analysis logic 327 may generate, according to estimated fatigue life 330, a maintenance plan 332, which may include generating a new maintenance plan 332 or updating an existing maintenance plan 332. Maintenance plan 332 may include an individualized maintenance recommendation for the rotorcraft component. The maintenance recommendation may include, for example, a recommendation to service the vehicle component, a recommendation to replace the vehicle component, or a recommendation to retire or replace rotorcraft 100.

Although functionality and data are shown grouped in a particular manner in FIG. 3, the functionality and/or data may be separated or combined differently, as may be appropriate for a particular implementation. As just one example, in certain embodiments, computer system 304 may communicate predicted fatigue load information 326 to another computer system, which may store estimated fatigue life mapping 328 and perform operations of estimating fatigue life 330 and generating maintenance plan 332. Computer system 302 and computer system 304 may be implemented using any suitable combination of hardware, firmware, and software. In certain embodiments, computer systems 302 and 304 may individually or collectively be implemented using a computer system such as the example described below with reference to FIG. 8.

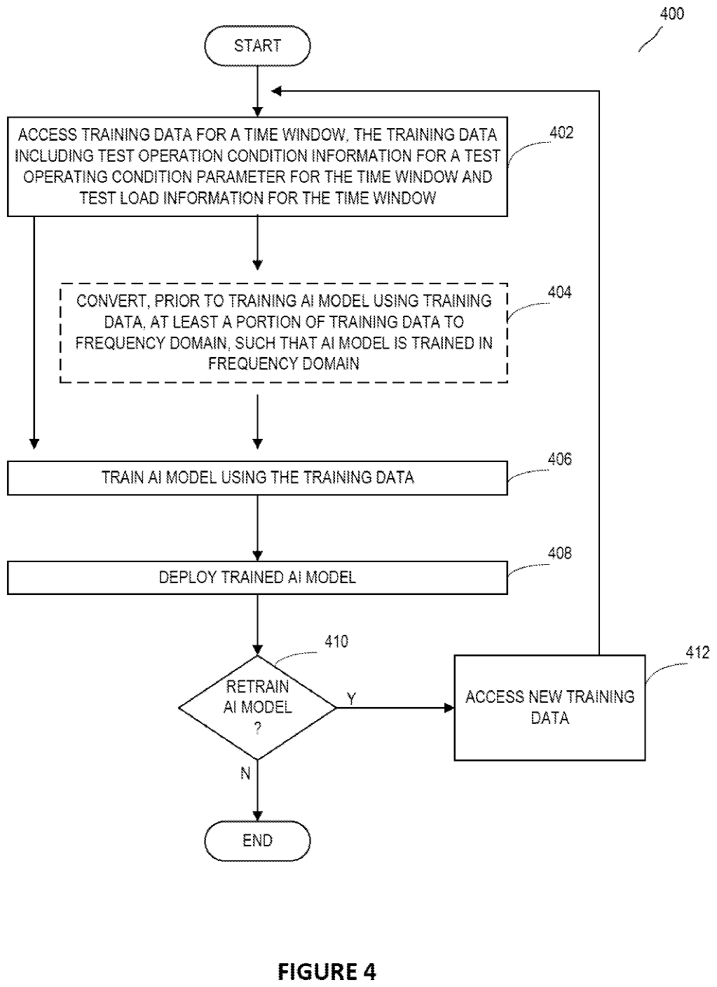

FIG. 4 illustrates a flow diagram of an example method 400 for training an AI model for generating predicted load information for a vehicle component, according to certain embodiments. Method 400 may be performed, in whole or in part, by one or more computer systems, and may be embodied, in whole or in part, in a software program stored on a non-transitory computer-readable storage medium that is executed by one or more processors of the one or more computer systems. Method 400 is described as being performed by computer system 302; however, this disclosure contemplates method 400 being performed by any suitable processing device.

At step 402, computer system 302 (e.g., training logic 316) accesses training data 314 for a time window. Training data 314 may include test operating condition information for a test operating condition of a test vehicle for the time window. The test operating condition information may correspond to sensor measurements associated with a vehicle component of the vehicle. The test operating condition may correspond to the actual operating condition of the vehicle. Training data 314 may further includes test load information for the time window. In certain embodiment, the time window for the test operating condition information for the test operation condition parameters matches the time window for the test load information.

In certain embodiments, training data 314 is collected from multiple test vehicle operations. The test vehicle operations may be actual vehicle operations or simulated vehicle operations.

In certain embodiments, the training data for the time window may be in a time domain format. At step 404, if desired and in certain embodiments, computer system 302 (e.g., training logic 316) may convert, prior to training the AI model using training data 314 for the selected time window, at least a portion of training data 314 to a frequency domain, such that the AI model is trained in the frequency domain. In certain embodiments, computer system 302 (e.g., training logic 316) may convert the test load information for the time window to the frequency domain, which may reduce the number of data points being observed.

At step 406, computer system 302 (e.g., training logic 316) may train AI model (e.g., in-training AI model 318) using the training data to generate trained AI model 320.

At step 408, computer system 302 (e.g., deployment logic 321) may deploy trained AI

model 320 for use in analyzing real-time usage data. For example, computer system 302 may deploy trained AI model 320 for installation on a computer system of a vehicle (e.g., on computer system 304) for trained AI model 320 to be used for determining predicted load information for actual operating condition information from sensors determining an operating condition of a vehicle component.

At step 410, computer system 302 may determine whether to retrain trained AI model 320. Computer system 302 could make this determination automatically based on programmed conditions or in response to user input requesting retraining of trained AI model 320.

If computer system 302 determines at step 410 to retrain trained AI model 320, then at step 412, computer system 302 (e.g., training logic 316) may access new training data 314. The method may then return to step 402 to access, from the new training data 318, training data for a time window and continuing with steps 404, 406, and 408 according to the new training data 318.

Returning to step 410, if computer system 302 determines at step 410 not to retrain AI model 320, the method ends.

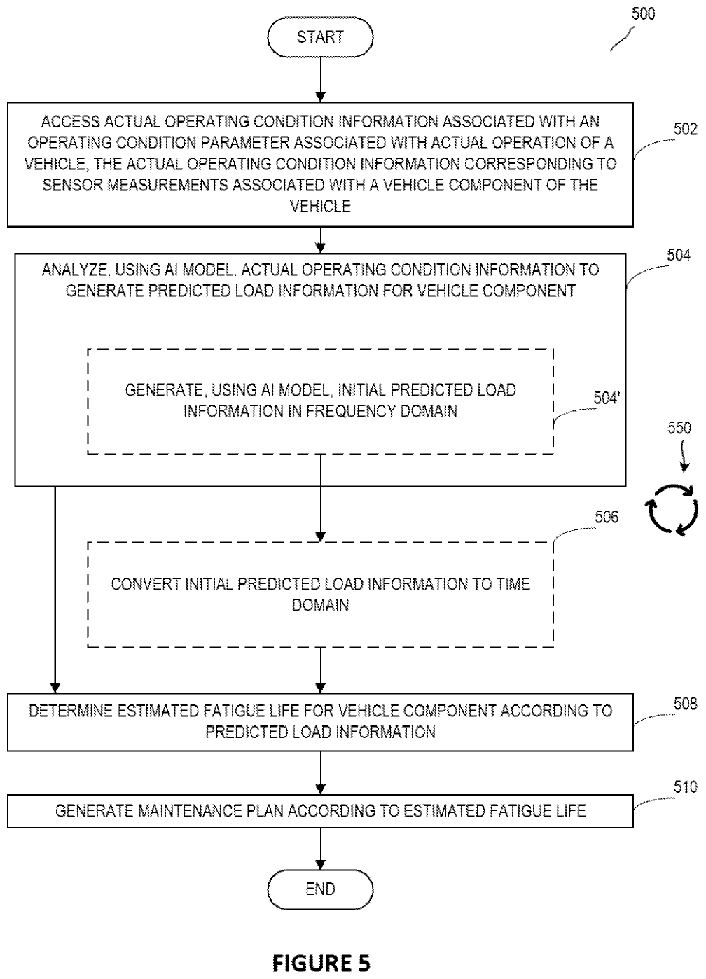

FIG. 5 illustrates a flow diagram of an example method 500 for predicting structural loads and estimating vehicle component fatigue, according to certain embodiments. Method 500 may be performed, in whole or in part, by one or more computer systems, and may be embodied, in whole or in part, in a software program stored on a non-transitory computer-readable storage medium that is executed by one or more processors of the one or more computer systems. Method 500 is described as being performed by computer system 304; however, this disclosure contemplates method 500 being performed by any suitable processing device.

At step 502, computer system 304 (e.g., monitoring logic 322 and/or AI analysis logic 324) may access actual operating condition information 325 for an operating condition parameter associated with actual operation of a vehicle (e.g., rotorcraft 100). The actual operating condition information may correspond to sensor measurements associated with a vehicle component of the vehicle. In certain embodiments, the sensor measurements are part of a data signal received from a sensor associated with the vehicle component. The sensor itself and/or monitoring module 322 may perform certain pre-processing on the data signal to generate actual operating condition information 325.

In certain embodiments, the vehicle is an aircraft, the operating condition parameter is a flight parameter associated with an actual flight of the aircraft, and the actual operating condition information associated with the operating condition parameter includes a data signal for the flight parameter.

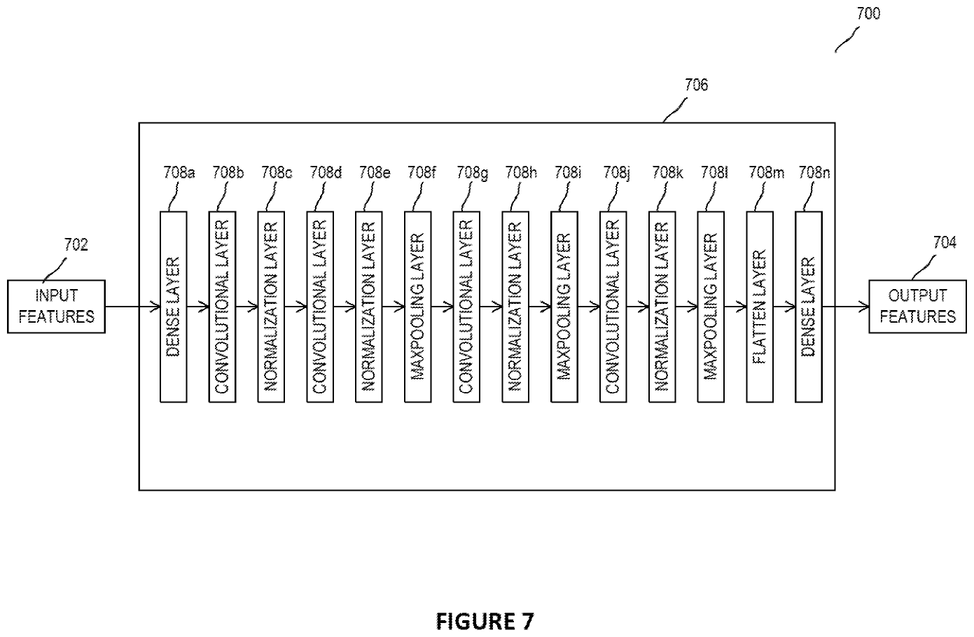

At step 504, computer system 304 (e.g., AI analysis logic 324) analyzes, using an AI model (e.g., trained AI model 320), actual operating condition information 325 to generate predicted load information 326 for the vehicle component. In certain embodiments, the AI model (e.g., trained AI model 320) includes multiple layers arranged in a processing sequence. The multiple layers may include at least one first dense layer and at least one second dense layer. The multiple layers also may include at least one convolutional layer, at least one normalization layer, and at least one pooling layer between the at least one first dense layer and the at least one second dense layer. Of course, the AI model may have other suitable designs. An example AI model is described below with reference to FIG. 7.

In certain embodiments, the AI model has been trained prior to deployment for use in method 500. For example, the AI model (e.g., trained AI model 320) may have been trained according to method 400, as described above with reference to FIG. 4.

In certain embodiments, the AI model (e.g., trained AI model 320) has been trained in a frequency domain. In such embodiments, if desired, computer system 304 may perform a step 504′ in which analyzing, using the AI model (e.g., trained AI model 320), the actual operating condition information 325 to generate the predicted load information 326 for the vehicle component includes generating, using the AI model (e.g., trained AI model 320), initial predicted load information 326 in the frequency domain. At step 506, computer system 304 (e.g., AI analysis logic 324 and/or post-prediction analysis logic 327) may convert the initial predicted load information 326 to a time domain format, a process that may be referred to as reconstructing predicted load information 326. In certain embodiments, computer system 304 may convert the initial predicted load information 326 to a time domain format using an inverse Fourier transform or other suitable technique.

In certain embodiments, if the AI model (e.g., trained AI model 320) remained in the time domain, then step 506 may be skipped.

At step 508, computer system 304 (e.g., post-prediction analysis logic) may determine, according to predicted load information 326, an estimated fatigue life 330 for the vehicle component that is individualized for the vehicle component.

At step 510, computer system 304 (e.g., post-prediction analysis logic) may generate, according to estimated fatigue life 330, a maintenance plan 332, which may include generating a new maintenance plan 332 or updating an existing maintenance plan 332. Maintenance plan 332 may include an individualized maintenance recommendation for the rotorcraft component. The maintenance recommendation may include, for example, a recommendation to service the vehicle component, a recommendation to replace the vehicle component, or a recommendation to retire or replace rotorcraft 100.

Although a single iteration of method 500 is described, in certain embodiments, method 500 is an iterative process, as indicated at iterative symbol 550, that may be repeated at suitable regular or irregular intervals. Furthermore, although a single AI model 320 for a particular rotorcraft component is described, in certain embodiments, additional AI models 320 may be trained and deployed for performing a similar analysis for other rotorcraft components. In certain embodiments, a separate AI model 320 is trained and deployed for each rotorcraft component for which determining predicted load information is desired. Additionally or alternatively, a particular AI model 320 may be trained and deployed for multiple rotorcraft components for which determining predicted load information is desired.

In examples in which predicted load information is generated for multiple rotorcraft components (whether determined using a single trained AI model 320 or separate respective trained AI models 320), computer system 304 may generate respective estimated fatigue lives for the vehicle components that are individualized for the vehicle components, and may generate separate individual maintenance plans for the vehicle components or a combined maintenance plan for the vehicle that includes individualized maintenance recommendations for the various vehicle components.

Methods 400 and 500 may be combined and performed using the systems and apparatuses described herein. Although shown in a logical order, the arrangement and numbering of the steps of methods 400 and 500 are not intended to be limited. The steps of methods 400 and 500 may be performed in any suitable order or concurrently with one another as may be apparent to a person of skill in the art.

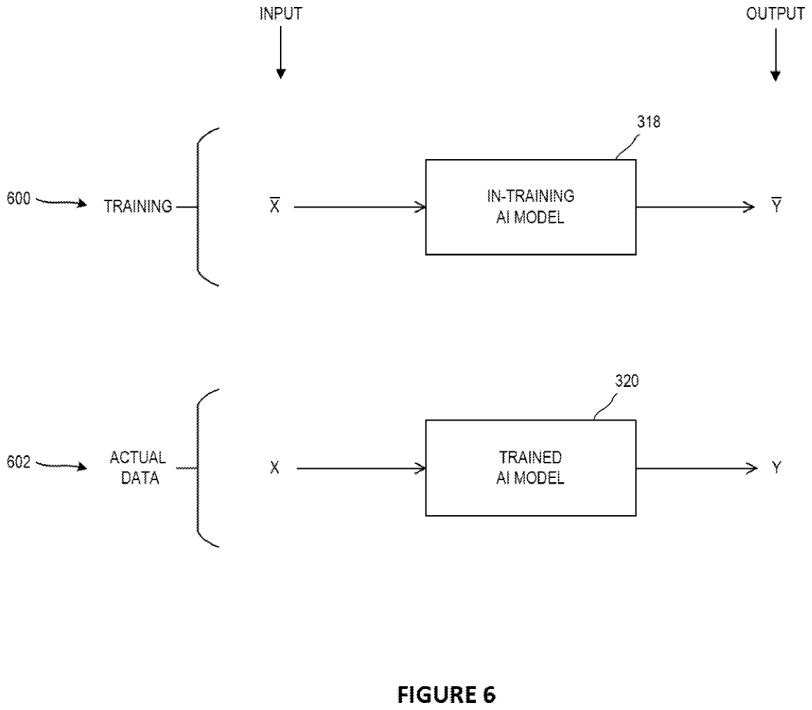

FIG. 6 illustrates additional details regarding training an AI model and processing actual data using the trained AI model, according to certain embodiments. In the illustrated example, both a training phase 600 and an actual data processing phase 602 are shown.

For training phase 600, the input into in-training AI model 318 is shown as, or X bar. X may correspond to one or more operating condition parameters. As described above, when training in-training AI model 318, a time window of training data 314 may be selected. For example, a time window of test operating condition information may be selected. Rather than inputting the entire operating condition information (e.g., data signal) for the entire time window, certain embodiments input a mean of the operating condition information (e.g., values of the data signal) over the time window. X bar represents that mean.\x \to (X)

Continuing with training phase 600, the output of in-training AI model 318 is shown as, or Y bar. The output is the load being predicted by in-training AI model 318. Training data 314 may include test load signals corresponding to the test operating condition parameters that are input into the in-training AI model 318. In this example, Y bar represents the test load signal (of training data 314) over the same time window that was used for calculating X bar. Furthermore, in certain embodiments, the test load signal may be converted to a frequency domain, and Y bar may by calculated after the conversion such that Y bar also is a value in the frequency domain.\x \to (Y)

For actual data processing phase 602, the input into trained AI model 320, which as described above has been trained using average values for X over various time windows, is shown as X. X may correspond to the same one or more operating condition parameters to which X bar corresponds. X may be a signal from actual operating condition information 325, and the values from the signal may be sampled at any suitable interval and input to trained AI model 320. Continuing with actual data process phase 602, the output of trained AI model 320 is shown as Y. Y represents predicted load information (e.g., a predicted load value) generated by trained AI model 320, which as described above has been trained using Y bar and average values for X over various time windows, based on input X. Y may be output as an output signal. In certain embodiments, due to the training of in-training AI model 318 using test load signals that have been converted to the frequency domain, trained AI model 320 outputs estimated load information (values) in a frequency domain such that a value for Y in actual data processing phase 602 is in the frequency domain. The Y values may be converted to a time domain, as described above.

The mean technique for sampling training data 318 for training in-training AI model 318 represents just one possible technique for training in-training AI model 318 to generate trained AI model 320.

FIG. 7 illustrates an example machine learning model 700, according to certain embodiments. Machine learning model 700 is just one example of an AI model that may be used for predicting estimated load information, according to the present disclosure. In certain embodiments, machine learning model 700 may be considered a deep learning model. In certain embodiments, an instance of machine learning model 700 corresponds to a particular vehicle component (or combination of vehicle components).

In general, input features 702 are input into machine learning model 700, and output features 704 are output by machine learning model 700. Input features 702 may include training data when machine learning model 700 is being trained or real-time operational condition information when machine learning model 700 is deployed. Input features 702 also could be referred to as the input layer, input variables, the visible layer, or other suitable terms. Output features 704 may include a predicted value (predicted load information for a rotorcraft component) as determined according to the machine learning model 700. Output features 704 also could be referred to as the output layer, output variables, or other suitable terms.

In the illustrated example machine learning model 700 includes hidden layers 706. In this example, hidden layers 706 include multiple layers 708a-708n, referred to collectively as layers 708 (or as hidden layers 706). Although machine learning model 700 is illustrated and described as including a particular number of layers 708 (e.g., a particular depth), machine learning model 700 may include any suitable number of layers 708, including one or more. Additionally, although machine learning model 700 is illustrated and described as including particular layers 708, machine learning model 700 may include any suitable layers 708 in any suitable combination. Additionally, although layers 708 of machine learning model 700 are illustrated and described in a particular order, layers 706 may be arranged in any suitable order. In other words, although machine learning model 700 is illustrated and described as having a particular architecture, this disclosure contemplates machine learning model 700 having any suitable architecture.

In general, a layer of a machine learning model is a structure or network topology in the model's architecture that receives information from previous layers and then passes the information to a next layer. For example, a layer may be a container that receives weighted input, transforms the weighted input with a set of potentially non-linear functions, and then passes these processed values as output to a next layer. In certain embodiments, a layer may be uniform in that the layer contains one type of activation function (e.g., pooling, convolution, or another type of activation). Layers in a deep learning model may include, for example, one or more dense layers (also called fully connected layers), one or more two-dimensional convolutional layers, one or more long short-term memory (LSTM) layers, one or more attention layers, and/or any other suitable types of layers in any suitable combination and order.

Each layer may include one or more nodes, the number of nodes being the width of that layer. Each node may correspond to an input to that layer.

In the illustrated example, machine learning model 700 includes dense layer 708a, convolutional layer 708b, normalization layer 708c, convolutional layer 708d, normalization layer 708e, MaxPooling layer 708f, convolutional layer 708g, normalization layer 708h, MaxPooling layer 708i, convolutional layer 708j, normalization layer 708k, MaxPooling layer 708l, flatten layer 708m, and dense layer 708n.

In general, dense layers (e.g., dense layers 708a and 708n) are used for abstract representations of input data. With each dense layer, neurons may be connected to each neuron in the preceding layer, and could be stacked, if appropriate.

In general, convolutional layers (e.g., convolutional layers 708b, 708d, 708g, and 708j) transform input data by convolving the input data with one or more filters (known as a kernel) to generate an output of the convolution layer. The process may be iterated over the data set with a window (known as a receptive field), the size of which may be chosen as desired. The displacement length of the receptive field is known as the stride and may also be chosen as desired. The output of a convolution layer may be dimensionally different (e.g. larger or smaller) than the input. As shown in FIG. 7, machine learning model 700 includes multiple convolutional layers (e.g., convolutional layers 708b, 708d, 708g, and 708j), which may allow hierarchical decomposition of the input. For example, each convolution layer may learn from previous convolutional layers to gain a deeper understanding of the data being analyzed.

In general, normalization layers (e.g., normalization layers 708c, 708e, 708h, and 708k) transforms a data set to be on a similar scale, such as between numerical range (e.g., 0 and 1 or between −1 and 1). Example normalization layers may include batch normalization, weight normalization, layer normalization, and group normalization.

In general, pooling layers (e.g., MaxPooling layers 708f, 708i, and 708l) are used to reduce the size of the input data. For example, pooling layers may down sample feature maps by summarizing the presence of features in patches of the feature map. Pooling techniques include average pooling, which calculates the average value for each patch of a feature map, and max pooling, which calculates the maximum value for each patch of a feature map. MaxPooling layers, for example, may highlight the most present feature in a patch of a feature map. The output of a pooling layer may be, for example, a smaller fully connected layer or a single classification.

In general, normalization layers (e.g., normalization layers 708c, 708e, 708h,and 708k) adjust data output from previous layers to attempt to achieve a regular distribution, which may improve scalability and model training.

In general, flatten layers (e.g., flatten layer 708m) convert a multidimensional output of a previous layer into a single, one-dimensional vector that can be used as an input for a dense layer (e.g., dense layer 708n). In other words, a flatten layer may collapse the spatial dimensions of the input into the channel dimension.

FIG. 8 is a block diagram of an example computer system 800, according to certain embodiments. Computer system 800 can be configured to perform one or more operations related to aircraft computer systems 114, including flight control computer 216, engine control computer 218, computer system 302, computer system 304, and/or other suitable computer systems (e.g., computer system 134) or other components of flight control system 200. For example, these systems and methods may be implemented using one or more computer systems 800. Further, any processing and analysis can be partly or fully performed by the computer system 800. Computer system 800 can be partly or fully integrated with other aircraft computer systems or can be partly or fully removed from rotorcraft 100.

Computer system 800 may be implemented using any suitable combination of hardware, firmware, and software. Computer system 800 includes processor 802, one or more memories 804, and interfaces 806-810, which may (or may not) be arranged as shown. Computer system 800 may include any suitable number of processors 802, memories 804, and interfaces 806-810.

Processor 802 may be any component or collection of components adapted to perform computations and/or other processing related tasks. Processor 802 may be a programmable logic device, a microcontroller, a microprocessor, any suitable processing device, or any suitable combination of the preceding.

Memory 804 may be any component or collection of components adapted to store programming and/or instructions for execution by the processor 802. Memory 804 may include any one or a combination of volatile or non-volatile local or remote devices suitable for storing information. For example, memory 804 may include random access memory (“RAM”), read-only memory (“ROM”), magnetic storage devices, optical storage devices, or any other suitable information storage device or a combination of these devices. Memory 804 may be, in whole or in part, local to or remote from rotorcraft 100. In an embodiment, the memory 804 includes a non-transitory computer-readable medium. Memory 804 may store one or more computer programs for execution by processor 802, the one or more computer programs includes instructions for performing operations and that when executed by the process cause the process to perform those operations.

Interfaces 806, 808, 810 may be any component or collection of components that allow computer system 800 to communicate with other devices/components and/or a user. For example, one or more of the interfaces 806, 808, 810 may be adapted to communicate data, control, or management messages from the processor 802 to applications installed on the host device and/or a remote device. As another example, one or more of the interfaces 806, 808, 810 may be adapted to allow a user or user device (e.g., personal computer (PC), etc.) to interact/communicate with aircraft computer systems 114. Aircraft computer systems 114 may include additional components not depicted, such as long term storage (e.g., non-volatile memory, etc.).

Embodiments of this disclosure may provide none, some, or all of the following technical advantages. Furthermore, other advantages may be described in or understood from this disclosure.

Certain embodiments of this disclosure provide for predicting dynamic structural load for components based on actual usage as measured by one or more sensors measuring operational condition information for operational condition parameters, the sensors being associated with those components. Certain embodiments include building a trained AI model to predict a real time dynamic load profile for certain components based on operational (e.g., flight) parameters measured by one or more sensors. In certain embodiments, these techniques can be integrated with existing production vehicles (e.g., aircraft) without hardware reconfiguration to assist health monitoring.

Certain embodiments provide high fidelity health monitoring information for aircraft or other vehicles or machines due at least in part to predicting dynamic load information for certain components. The load prediction may be used for fatigue analysis to estimate fatigue life of critical components and to provide high fidelity maintenance operations. Based on the predicted dynamic load, the fatigue life of those components can be estimated accordingly based on actual usage. This capability may allow generation of a customized maintenance plan to reduce maintenance burden. In certain embodiments, this system generates the model in the frequency domain using AI technologies (e.g., deep learning) and reconstructs the signal back to the time domain, which may provide high accuracy and efficiency.

Certain embodiments of this disclosure more accurately predict the life span of components of an aircraft based on actual flight usage and models trained using machine learning (e.g., deep learning) algorithms, which can reduce wasted resources in terms of financial cost, time, and other factors stemming from early service, retirement, and/or replacement of a vehicle component and/or vehicle.

In certain embodiments, rather than relying on certain complex sensors that can be difficult to install (though, of course, this disclosure contemplates using any suitable types of sensors), sensors that are generally straightforward to install (e.g., accelerometers that measure vibrations proximate vehicle components of interest) may be used to collect sensor data. This may reduce costs and complexity relative to systems that might attempt to install sensors on certain types of components for which installation of sensors may be difficult.

Example embodiments of this disclosure are summarized here. Other embodiments can also be understood from the entirety of the specification as well as the claims filed herein.

Example 1. A rotorcraft includes a rotorcraft component, a plurality of sensors, and one or more non-transitory computer storage media storing programming for execution by one or more processors. The programming includes instructions to access actual operating condition information for operating condition parameters of the rotorcraft. The actual operating condition information corresponds to sensor measurements from the plurality of sensors and is associated with the rotorcraft component. The programming includes instructions to analyze, using an artificial intelligence model, the actual operating condition information to generate initial predicted load information for the rotorcraft component. The initial predicted load information includes a first output data signal in a frequency domain. The programming includes instructions to convert the initial predicted load information to a time domain to generate predicted load information for the rotorcraft component by applying a transform operation to the first output data signal to generate a second output data signal in a time domain. The programming includes instructions to determine, according to the predicted load information, an estimated fatigue life for the rotorcraft component that is individualized for the rotorcraft component.

Example 2. The rotorcraft of Example 1, where the artificial intelligence model includes a plurality of layers arranged in a processing sequence, the plurality of layers including: at least one first dense layer; at least one second dense layer; and between the at least one first dense layer and the at least one second dense layer: at least one convolutional layer; at least one normalization layer; and at least one pooling layer.

Example 3. The rotorcraft of any one of Examples 1 and 2, where the rotorcraft component includes: a pitch link of the rotorcraft; a fuselage of the rotorcraft; or one or more rotor blades of the rotorcraft.

Example 4. The rotorcraft of any one of Examples 1-3, where the artificial intelligence model has been trained according to a training phase that includes accessing training data for a time window, the training data including: test operating condition information for a test operating condition of a test rotorcraft, the test operating condition information corresponding to sensor measurements associated with a rotorcraft component of the rotorcraft, the test operating condition corresponding to the operating condition parameter of the rotorcraft; and test load information for a training operating condition of one or more test rotorcraft. The training phase further includes training the artificial intelligence model using the training data.

Example 5. The rotorcraft of Example 4, where: the training data for the time window is in a time domain; and the training phase further includes converting, prior to training the artificial intelligence model using the training data, at least a portion of the training data to a frequency domain, such that the artificial intelligence model is trained in the frequency domain.

Example 6. The rotorcraft of any one of Examples 1-5, where the programming further includes instructions to generate, according to the estimated fatigue life for the rotorcraft component, a maintenance plan that includes an individualized maintenance recommendation for the rotorcraft component.

Example 7. A method includes accessing, by a processing device, actual operating condition information for an operating condition parameter associated with actual operation of a vehicle. The actual operating condition information corresponds to sensor measurements associated with a vehicle component of the vehicle. The method includes analyzing, by the processing device and using an artificial intelligence model, the actual operating condition information to generate predicted load information for the vehicle component. The method includes determining, according to the predicted load information, an estimated fatigue life for the vehicle component that is individualized for the vehicle component.

Example 8. The method of Example 7, where: the sensor measurements are part of a data signal received from a sensor associated with the vehicle component; and the method further includes performing pre-processing on the data signal to generate the actual operating condition information.

Example 9. The method of any one of Examples 7-8, where: the vehicle is an aircraft, the operating condition parameter includes a flight parameter associated with an actual flight of the aircraft, and the actual operating condition information associated with the operating condition parameter includes a data signal for the flight parameter.

Example 10. The method of any one of Examples 7-9, where the artificial intelligence model includes a plurality of layers arranged in a processing sequence, the plurality of layers including: at least one first dense layer; at least one second dense layer; and between the at least one first dense layer and the at least one second dense layer; at least one convolutional layer; at least one normalization layer; and at least one pooling layer.

Example 11. The method of any one of Examples 7-10, where the artificial intelligence model has been trained according to training data that includes: test operating condition information associated with a test operating condition of a test vehicle, the test operating condition information corresponding to sensor measurements associated with a vehicle component of the test vehicle under the test operating condition; and one or more test load signals.

Example 12. The method of Example 11, where: the artificial intelligence model has been trained in a frequency domain; analyzing, by the processing device and using the artificial intelligence model, the actual operating condition information to generate the predicted load information for the vehicle component includes generating, by the processing device using the artificial intelligence model, initial predicted load information in the frequency domain; and the method further includes converting, by the processing device, the initial predicted load information to a time domain.

Example 13. The method of any one of Examples 7-12, further including executing a training phase for training the artificial intelligence model, the training phase including accessing training data for a time window, the training data including: test operating condition information for a test operating condition of a test vehicle, the test operating condition information corresponding to sensor measurements associated with a vehicle component of the vehicle, the test operating condition corresponding to the actual operating condition of the vehicle; and test load information for the time window. The training phase further includes training the artificial intelligence model using the training data.

Example 14. The method of Example 13, where: the training data for the time window is in a time domain; and the method further includes converting, prior to training the artificial intelligence model using the training data, at least a portion of the training data to a frequency domain, such that the artificial intelligence model is trained in the frequency domain.

Example 15. The method of any one of Examples 13-14, where the training data is collected from a plurality of test vehicle operations, the test vehicle operations being actual vehicle operations or simulated vehicle operations.

Example 16. The method of any one of Examples 7-15, further including generating, according to the estimated fatigue life for the vehicle component, a maintenance plan that includes an individualized maintenance recommendation for the vehicle component.

Example 17. A computer system includes one or more processing units and one or more non-transitory computer-readable storage media storing programming for execution by the one or more processing units. The programming includes instructions to access actual operating condition information for an operating condition parameter associated with actual operation of a vehicle. The actual operating condition information corresponds to sensor measurements associated with a vehicle component of the vehicle. The programming includes instructions to analyze, using an artificial intelligence model, the actual operating condition information to generate predicted load information for the vehicle component. The programming includes instructions to determine, according to the predicted load information, an estimated fatigue life for the vehicle component that is individualized for the vehicle component.

Example 18. The computer system of Example 17, where the computer system is located on board the vehicle.

Example 19. The computer system of any one of Examples 17-18, where the artificial intelligence model has been trained according to a training phase that includes accessing training data for a time window, the training data including: test operating condition information for a test operating condition of a test vehicle, the test operating condition information corresponding to sensor measurements associated with a vehicle component of the vehicle, the test operating condition corresponding to the operating condition parameter of the vehicle; and test load information for a training operating condition of one or more test vehicle. The training phase further includes training the artificial intelligence model using the training data.

Example 20. The computer system of any one of Examples 17-19, where the programming further includes instructions to generate, according to the estimated fatigue life for the vehicle component, a maintenance plan that includes an individualized maintenance recommendation for the vehicle component.

Illustrative embodiments of the system and method of the present disclosure are described herein. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Various techniques have been described as multiple discrete operations to assist in understanding the various embodiments. The order of description should not be construed as to imply that these operations are necessarily order dependent. Operations described may be performed in a different order than the described embodiment. Various additional operations may be performed and/or described operations may be omitted in additional embodiments.

While this disclosure has been described with reference to illustrative embodiments, this description is not intended to be construed in a limiting sense. Various modifications and combinations of the illustrative embodiments, as well as other embodiments of this disclosure, will be apparent to persons skilled in the art upon reference to the description. It is therefore intended that the appended claims encompass any such modifications or embodiments.

What is claimed is:

1. A rotorcraft, comprising:
a rotorcraft component;
a plurality of sensors;
one or more non-transitory computer storage media storing programming for execution by one or more processors, the programming comprising instructions to:
access actual operating condition information for operating condition parameters of the rotorcraft, the actual operating condition information corresponding to sensor measurements from the plurality of sensors and associated with the rotorcraft component;
analyze, using an artificial intelligence model, the actual operating condition information to generate initial predicted load information for the rotorcraft component, the initial predicted load information comprising a first output data signal in a frequency domain;
convert the initial predicted load information to a time domain to generate predicted load information for the rotorcraft component by applying a transform operation to the first output data signal to generate a second output data signal in a time domain;
determine, according to the predicted load information, an estimated fatigue life for the rotorcraft component that is individualized for the rotorcraft component.

2. The rotorcraft of claim 1, wherein the artificial intelligence model comprises a plurality of layers arranged in a processing sequence, the plurality of layers comprising:
at least one first dense layer;
at least one second dense layer; and
between the at least one first dense layer and the at least one second dense layer:
at least one convolutional layer;
at least one normalization layer; and
at least one pooling layer.

3. The rotorcraft of claim 1, wherein the rotorcraft component comprises:
a pitch link of the rotorcraft;
a fuselage of the rotorcraft; or
one or more rotor blades of the rotorcraft.

4. The rotorcraft of claim 1, wherein the artificial intelligence model has been trained according to a training phase that comprises:
accessing training data for a time window, the training data comprising:
test operating condition information for a test operating condition of a test rotorcraft, the test operating condition information corresponding to sensor measurements associated with a rotorcraft component of the rotorcraft, the test operating condition corresponding to the operating condition parameter of the rotorcraft; and
test load information for a training operating condition of one or more test rotorcraft; and
training the artificial intelligence model using the training data.

5. The rotorcraft of claim 4, wherein:
the training data for the time window is in a time domain; and
the training phase further comprises converting, prior to training the artificial intelligence model using the training data, at least a portion of the training data to a frequency domain, such that the artificial intelligence model is trained in the frequency domain.

6. The rotorcraft of claim 1, wherein the programming further comprises instructions to generate, according to the estimated fatigue life for the rotorcraft component, a maintenance plan that comprises an individualized maintenance recommendation for the rotorcraft component.

7. A method, comprising:
accessing, by a processing device, actual operating condition information for an operating condition parameter associated with actual operation of a vehicle, the actual operating condition information corresponding to sensor measurements associated with a vehicle component of the vehicle;
analyzing, by the processing device and using an artificial intelligence model, the actual operating condition information to generate predicted load information for the vehicle component; and
determining, according to the predicted load information, an estimated fatigue life for the vehicle component that is individualized for the vehicle component.

8. The method of claim 7, wherein:
the sensor measurements are part of a data signal received from a sensor associated with the vehicle component; and
the method further comprises performing pre-processing on the data signal to generate the actual operating condition information.

9. The method of claim 7, wherein:
the vehicle is an aircraft;
the operating condition parameter comprises a flight parameter associated with an actual flight of the aircraft; and
the actual operating condition information associated with the operating condition parameter comprises a data signal for the flight parameter.

10. The method of claim 7, wherein the artificial intelligence model comprises a plurality of layers arranged in a processing sequence, the plurality of layers comprising:
at least one first dense layer;
at least one second dense layer; and
between the at least one first dense layer and the at least one second dense layer:
at least one convolutional layer;
at least one normalization layer; and
at least one pooling layer.

11. The method of claim 7, wherein the artificial intelligence model has been trained according to training data that comprises:
test operating condition information associated with a test operating condition of a test vehicle, the test operating condition information corresponding to sensor measurements associated with a vehicle component of the test vehicle under the test operating condition; and
one or more test load signals.

12. The method of claim 11, wherein:
the artificial intelligence model has been trained in a frequency domain;
analyzing, by the processing device and using the artificial intelligence model, the actual operating condition information to generate the predicted load information for the vehicle component comprises generating, by the processing device using the artificial intelligence model, initial predicted load information in the frequency domain; and
the method further comprises converting, by the processing device, the initial predicted load information to a time domain.

13. The method of claim 7, further comprising executing a training phase for training the artificial intelligence model, the training phase comprising:
accessing training data for a time window, the training data comprising:
test operating condition information for a test operating condition of a test vehicle, the test operating condition information corresponding to sensor measurements associated with a vehicle component of the vehicle, the test operating condition corresponding to the actual operating condition of the vehicle; and
test load information for the time window; and
training the artificial intelligence model using the training data.

14. The method of claim 13, wherein:
the training data for the time window is in a time domain; and
the method further comprises converting, prior to training the artificial intelligence model using the training data, at least a portion of the training data to a frequency domain, such that the artificial intelligence model is trained in the frequency domain.

15. The method of claim 13, wherein the training data is collected from a plurality of test vehicle operations, the test vehicle operations being actual vehicle operations or simulated vehicle operations.

16. The method of claim 7, further comprising generating, according to the estimated fatigue life for the vehicle component, a maintenance plan that comprises an individualized maintenance recommendation for the vehicle component.

17. A computer system, comprising:
one or more processing units; and
one or more non-transitory computer-readable storage media storing programming for execution by the one or more processing units, the programming comprising instructions to:
access actual operating condition information for an operating condition parameter associated with actual operation of a vehicle, the actual operating condition information corresponding to sensor measurements associated with a vehicle component of the vehicle;
analyze, using an artificial intelligence model, the actual operating condition information to generate predicted load information for the vehicle component; and
determine, according to the predicted load information, an estimated fatigue life for the vehicle component that is individualized for the vehicle component.

18. The computer system of claim 17, wherein the computer system is located on board the vehicle.

19. The computer system of claim 17, wherein the artificial intelligence model has been trained according to a training phase that comprises:
accessing training data for a time window, the training data comprising:
test operating condition information for a test operating condition of a test vehicle, the test operating condition information corresponding to sensor measurements associated with a vehicle component of the vehicle, the test operating condition corresponding to the operating condition parameter of the vehicle; and
test load information for a training operating condition of one or more test vehicle; and
training the artificial intelligence model using the training data.

20. The computer system of claim 17, wherein the programming further includes instructions to generate, according to the estimated fatigue life for the vehicle component, a maintenance plan that comprises an individualized maintenance recommendation for the vehicle component.
